(19) United States
(12) Patent Application Publication
(10) Pub. No.: US 2003/0159839 A1
(43) Pub. Date: Aug. 28, 2003

(54) Tubular pipe helix blade system

(76) Inventor: Howard A. Perko, Fort Collins, CO (US)

Correspondence Address: WOOD, HERRON & EVANS, LLP, 2700 CAREW TOWER, 441 VINE STREET, CINCINNATI, OH, 45202, US

(21) Appl. No.: 10/129,229

(22) PCT Filed: Feb. 25, 2002
(86) PCT No.: PCT/US02/05514

(51) Int. Cl. A01B 33/00

(52) U.S. Cl. 172/100

(57) ABSTRACT

A tubular pipe helix system (10) includes a coupler (16) which has a sleeve (60 or 70) which is affixed internally or externally of, and in overlapping relationship with, an end (36) of one shaft (12) to create an enhanced wall thickness (W3) thereat and which is to be received in a collar (52) affixed to one end (40) of another shaft (14), with the two shafts able to be connected together by a single bolt (50) extending through the sleeve (60 or 70), the end (36) of the shaft (12), and collar (52) so as to transmit high torque without the need for multiple bolts.

### BACKGROUND OF THE INVENTION

I. Field of the Invention

The present invention relates to helix blade systems, and more particularly to helix blade systems which use tubular pipes or shafts.

II. Description of Prior Art

Helix blade systems are well known to provide support for foundations, piering to lift sunken foundations, or to tie back walls or provide other mounting supports, by way of example. Such systems include an elongated shaft in the form of a solid rod or a hollow pipe to which are mounted one or more helix blades. The proximal or trailing end of the shaft is caused to rotate, such as by application of torque from the shaft of a torque motor driver attached thereto, so as to rotate the helix blade(s) into the ground. Examples of helix blade systems are shown in my U.S. Pat. No. 6,058,662, and in U.S. Pat. Nos. 5,171,107; 3,999,391; and 3,810,364 to name a few. In some cases, the blade(s) are to be driven into the ground to a depth that is deeper than the length of the shaft supporting the blade(s). In that case, a second or extension shaft may be attached at its distal or leading end to the trailing end of the preceding shaft, such as with a socket or collar mounted to the end of one of the shafts and receiving the adjacent end of the other shaft therein. Torque is then applied to the trailing end of the second shaft to thereby rotate the blade deeper into the ground. Successive extension shafts may be so applied.

Typical of solid shafts is one inch square. However, the solid shafts have a tendency to twist and so can not withstand the high torques desired to be applied to drive the helix blade system. Tubular pipes, such as cylindrical pipes, are believed to be better able to withstand high torque without twisting. The trailing end of the main shaft and the leading end of driver shaft or extension shaft are held together with two or more bolts extending through bolt holes provided through one of the ends and the collar on the other end, for example. There is a belief that a plurality of bolts is necessary in order to withstand the high torques to be applied, such as 10,000 ft-lb, and possibly as high as in the range of 12,000 ft-lb.

In the field, the use of multiple bolts presents several drawbacks. There must be sufficient bolts available on the job site; there are labor and parts costs to deal with; and the complexity of the job is increased. Moreover, where an extension shaft is to be bolted to the preceding shaft, the preceding shaft may have been driven near or well into the around making access for application of multiple bolts a difficult and tedious task. And should the operator fail to include the required number of bolts, the system might fail.

### SUMMARY OF THE INVENTION

Typically, the installation procedure for each section of a helix blade system involves attaching the section to the torque motor, rotationally driving the section into the ground, removing the section from the torque motor, attaching the next section, and repeating the process. The attachment to the torque motor is typically the same as the attachment between sections. Hence, each attachment must be made, unmade, and remade for every section. Helix blade systems commonly require four or more sections. Rotational driving into the ground is a comparatively quick process. Hence, the making and unmaking of attachments comprises much of the time required for installation of helix blade systems. The number of bolts required for each section attachment is perhaps the most important factor governing helix blade system installation time.

The axial holding capacity of a helix blade system in the ground is directly proportional to the installation torque. Therefore, the torsional strength of a helix blade system and that of attachments between sections govern the overall performance of the total helix-blade system in supporting foundation loads, in an underpinning capacity, or in serving as an earth anchor.

Contrary to widely believed misconceptions regarding helix blade system attachments, the number of bolts use in making an attachment is not a significant factor affecting its torsional strength. The torsional shear strength of a tubular shaft with a given diameter depends on the rotational moment of inertia which is primarily a function of cross-sectional area. Therefore, increasing the cross-sectional area of an attachment can increase the torsional strength of a helix blade system.

The present invention provides an improved tubular pipe helix blade system which may be attached with only a single bolt, and yet has improved torsional strength. To this end, and in accordance with the principles of the present invention, an attachment end of a tubular shaft is provided with a sleeve fitted over (external of) or within (internal of) the shaft at that end so as to provide an enhanced wall thickness to the cylindrical wall at the attachment end of the shaft, and thus increased cross-sectional area of the attachment. The sleeve and the attachment end of the shaft are provided with a bolt receiver, such as holes extending transverse to the longitudinal axis of the shaft. The end of the shaft may be the trailing end of a shaft, adapted to fit into the driver shaft or a collar of the next shaft, or may be at the distal or leading end of a shaft adapted to fit into a collar of the preceding shaft. In either case, the shaft and the sleeve present a coaxial pair of cylindrical pipe sections that have a collective wall thickness greater than the wall thickness of just the shaft end. As a consequence, the shaft end may be attached to the driver shaft or adjacent shaft by only one bolt while able to transmit the high torques expected to be encountered.

Advantageously, the sleeve and shaft end are affixed together. In one embodiment, they may be affixed by plug welding. To this end, a hole is formed on the exterior component (the shaft if the sleeve is internal of the shaft, and the sleeve if it is external of the shaft), and the hole is used to create a plug weld thereat to the sleeve or shaft therewithin. There may be more than one hole and plug weld, such as an opposed pair. Other affixation techniques may be used, as will be easily understood by those skilled in the art. Further advantageously, the shaft and the sleeve may be cylindrical and the inner diameter of the shaft end and the outer diameter of the sleeve where the sleeve is internal of the shaft, or the inner diameter of the sleeve and the outer diameter of the shaft end where the sleeve is external of the shaft, are approximately equal so that the fit is snug. Yet further, the sleeve may extend beyond the adjacent end of the shaft so as to project therefrom, or may be flush to or behind the end of the shaft, provided that there is a length of sleeve above and below the bolt receiver holes formed therein.

In accordance with a yet further aspect of the present invention, the wall thickness of the shaft and the wall thickness of the sleeve are approximately the same. As a consequence, there is provided at the attachment end of the shaft a double wall thickness.

With the improved helix blade system of the present invention, the shaft end may be attached to the driver shaft or adjacent shaft by only one bolt while able to transmit the high torques expected to be encountered. By virtue of the foregoing, there is thus provided an improved tubular pipe helix blade system which may be attached by a single bolt, and yet has improved torsional strength. These and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a perspective view of an exemplary helix blade system for purposes of explaining the principles of the present invention;

FIG. 2 is a cross-sectional view of one embodiment of the trailing end of the lower shaft of the helix blade system of FIG. 1 showing a sleeve internal of the shaft in accordance with the principles of the present invention;

FIG. 3 is a view taken along line 3-3 of FIG. 2;

FIG. 4 is a cross-sectional view of the one embodiment of the leading end of the upper shaft of the helix blade system of FIG. 1 showing a collar for receiving the trailing end embodiment of FIG. 2;

FIG. 5 is a cross-sectional view of another embodiment of the trailing end of the lower shaft of the helix blade system of FIG. 1 showing a sleeve external of the shaft in accordance with the principles of the present invention;

FIG. 6 is a view taken along line 6-6 of FIG. 5;

FIG. 7 is a cross-sectional view of another embodiment of the leading end of the upper shaft of the helix blade system of FIG. 1 showing a collar for receiving the trailing end embodiment of FIG. 5;

FIG. 8 is a schematic view of a torque motor drive with an upper shaft from FIG. 1;

FIG. 9 is a perspective view of one embodiment of an extension shaft having the sleeve and collar embodiments of FIGS. 2-4;

FIG. 10 is a perspective view of another embodiment of an extension shaft having the sleeve and collar embodiments of FIGS. 5-7; and

FIG. 11 is a perspective view of a building structure supported by a plurality of helix blade systems of FIG. 1 for purposes of explaining use of the present invention.

### DETAILED DESCRIPTION OF THE DRAWINGS

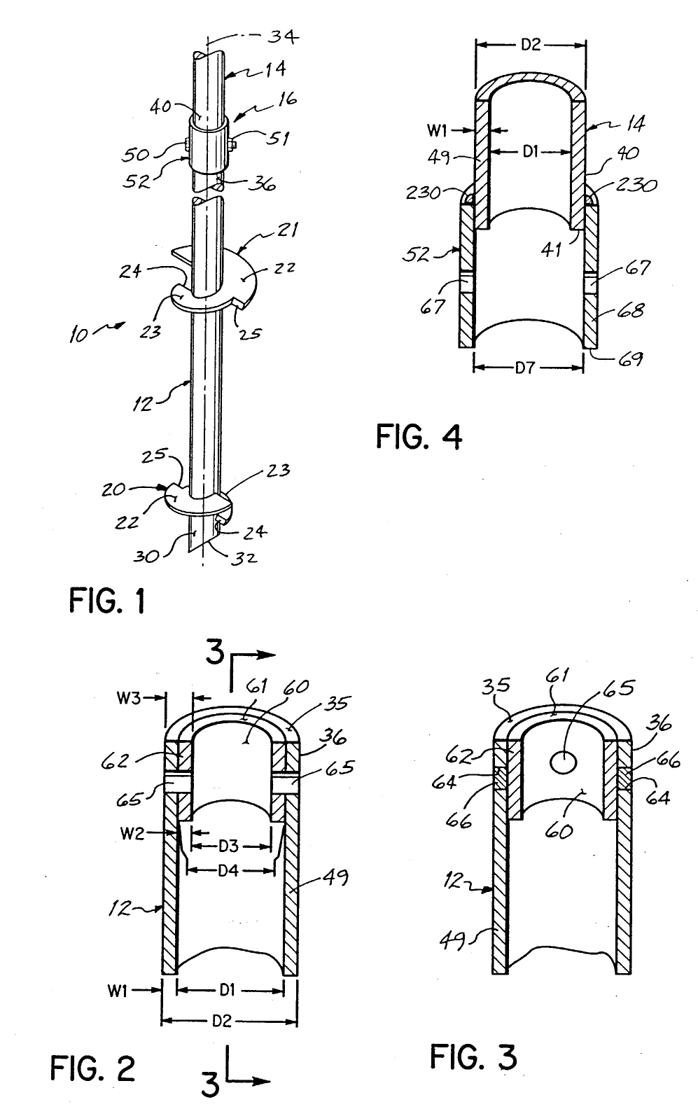

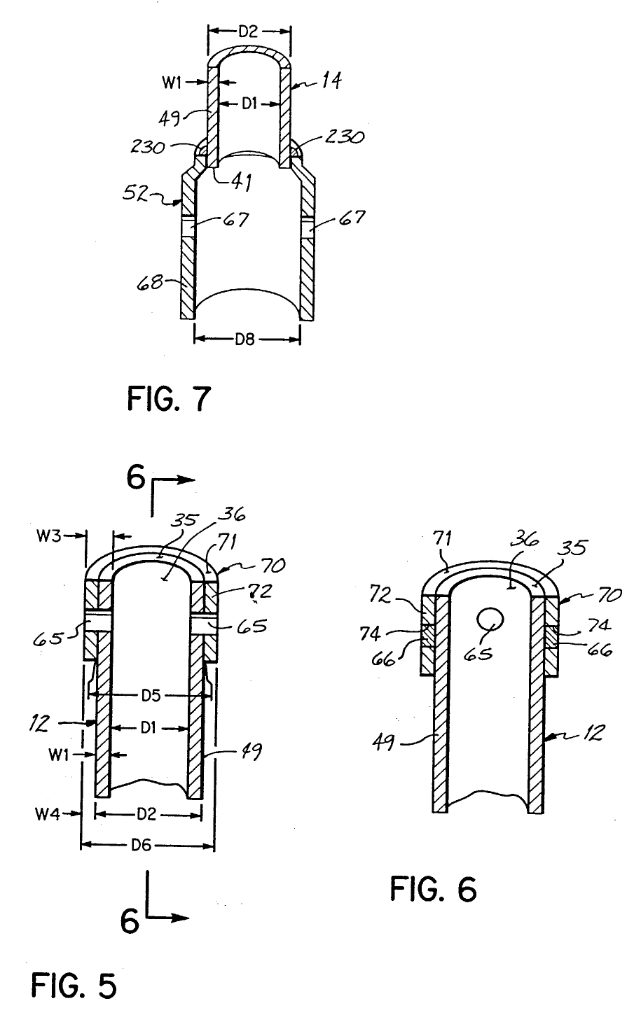

With reference to FIG. 1 there is shown a tubular pipe helix blade system 10 comprised of a lower shaft 12 and an upper shaft 14 joined together as at coupler 16 as will be described hereinafter. Shaft 12 may be in the form of a cylindrical steel pipe with a helix blade 20 mounted thereto. One or more additional helix blade(s) 21 (only one shown) may also be mounted to pipe 12 spaced from blade 20 as will be readily appreciated by those skilled in the art. Blades 20 and 21 (if provided) may be conventional helix blades, or may be as shown in my aforementioned U.S. Pat. No. 6,058,662. In the embodiment shown herein, each blade 20, 21 has a dual cutting edge provided by forming one half 22 of the blade to a first radius which may be larger for blade 21 than for blade 20. The other, opposite half 23 is formed to a second radius which may also be larger for blade 21 than blade 20, but which is less than the first radius of the associated blade. The smaller radius portion 23 of each blade is advantageously displaced below the larger radius portion along shaft 12. The leading cutting edges 24, 25 on the blades may be beveled to facilitate cutting in of the blade into the ground 200 (FIG. 11) as will be described hereinafter. The distal or leading end 30 of shaft 12 may be formed to enhance cutting into ground 200. To this end, a beveled edge 32 may be formed at end 30 as shown in FIG. 1, or a point (not shown) may be formed along the longitudinal axis 34 of shaft 12 such as by a solid end segment (not shown) attached to end 30. Other configurations for end 30 may be utilized as desired. The edge 35 (FIGS. 2 and 5) of proximal or trailing end 36 of pipe 12 is generally perpendicular to longitudinal axis 34 of pipe 12, and end 36 is to be coupled to shaft 14 as at 16 as will be hereinafter described.

Upper shaft 14 is also formed by a cylindrical steel pipe having at least a distal or leading end 40 to couple to pipe 12. The edge 41 of leading end 40 is also advantageously perpendicular to longitudinal axis 34 thereof. Although the dimensions need not be the same, for purposes of describing the invention, common diameters will be used for pipes 12 and 14 to simplify the discussion. To this end, pipes 12 and 14 each have a cylindrical sidewall 49 (see FIGS. 2-7) defining a wall thickness W1 between the inner diameter D1 and outer diameter D2 thereof. Typically, the wall thickness W1 is about ⅛ inch or about ¼ inch, with an outer diameter D2 of about 3 inches.

In accordance with the principles of the present invention, it is desired to couple the end 36 of shaft 12 to the end 40 of shaft 14 advantageously using one bolt 50, such as a Grade 5 bolt or better, with improved torsional strength by providing a greater cross-sectional area so as to obtain torque strength such as 10,000 ft.lb, and possibly in the neighborhood of 12,000 ft. lb. To this end, the coupling 16 occurs at the attachment ends 36 and/or 40 of pipes 12 and 14 by providing one of those ends 36 or 40 with a tubular, such as cylindrical, steel collar 52 and the other of those ends 36 or 40 with an enhanced wall thickness by addition of a tubular, such as cylindrical, steel sleeve 60 (internal) or 70 (external) as will be described with reference to FIGS. 2-4 and 5-7, respectively. For sake of simplicity, collar 52 will be described as attached to end 40 of pipe 14, with sleeve 60 or 70 being mounted or affixed along the end 36 of pipe 12, although it will be appreciated that the collar could be on end 36 and the sleeve along end 40.

Looking first at the internal sleeve 60, with reference to FIGS. 2 and 3, sleeve 60 has a sidewall 62 of predetermined thickness W2 as defined between its inner diameter D3 and its outer diameter D4. The outer diameter D4 of sleeve 60 is approximately equal to or slightly less than inner diameter D1 of pipe 12 so as to fit internal of pipe 12 at end 36, and advantageously snugly therein. Sleeve 60 is affixed to pipe 12 so as to extend along and into end 36 thereof and in overlapping or coaxial relationship therewith. Sleeve 60 may also extend outwardly therefrom or may be recessed therefrom (both not shown), although in the embodiment shown, sleeve 60 ends at edge 61 generally flush with edge 35 of pipe 12. One or more one inch diameter apertures 64 (FIG. 3) are formed about 2¾ inches from the edge 35 in sidewall 49 of pipe 12 adjacent sleeve 60 so as to expose sidewall 62 thereof through the apertures 64. A plug weld 66 is formed to fill flush each aperture 64 to secure sleeve 60 to pipe 12 with a 70 KSI minimum yield weld.

Aligned one inch diameter bolt holes 65 are provided through the sidewalls 49 and 62 about two inches from the edges 35 and 61 and at 90° to welds 66 (if an oppositely disposed pair is provided as shown) to receive therethrough a Grade 5 (or better) bolt 50 (FIG. 1). Bolt 50 thus interacts with the bolt holes 65 of both sleeve 60 and pipe 12, for example. Collar 52 for use with the embodiment of FIGS. 2 and 3 has an inner diameter D7 approximately equal to or slightly larger than the outer diameter D2 of pipe 12 so as to removably receive therein pipe end 36 with sleeve 60. One inch diameter bolt holes 67 are provided in collar wall 68, about two inches from edge 69, to also receive bolt 50 and secure pipe end 36 to pipe end 40.

With sleeve 60 internal of pipe 12, there is provided a coaxial pair of pipe sections 36, 60 with a collective wall thickness W3 greater than wall thickness W1. Advantageously, wall thickness W2 of sleeve 60 is approximately equal to wall thickness W1 so as to provide at end 36 a double wall thickness of pipe for joining to pipe 14. The collective wall thickness W3 is believed to provide the ability to withstand the transfer of torque between shafts 12 and 14 at the high levels of torque expected to be encountered while advantageously using one bolt 50 to couple shafts 12 and 14 together, thereby eliminating the need for, and drawbacks associated with use of, multiple bolts to couple the shafts together.

With reference to FIGS. 5 and 6, the enhanced wall thickness W3 may also be achieved by placing sleeve 70 external of shaft 12, rather than placing sleeve 60 internal thereof. To this end, sleeve 70 has a sidewall 72 of predetermined thickness W4 as defined between its inner diameter D5 and its outer diameter D6. The inner diameter D5 of sleeve 70 is approximately equal to or slightly larger than outer diameter D2 of pipe 12 so as to fit external of pipe 12 at end 36, and advantageously snugly therealong. Sleeve 70 is affixed to pipe 12 so as to extend along end 36 thereof in overlapping or coaxial relationship, and may also extend outwardly therefrom or be recessed therefrom (both not shown), although in the embodiment shown, the edge 71 of sleeve 70 ends flush with edge 35 at end 36 of pipe 12. One or more one inch apertures 74 are formed in sidewall 72 of sleeve 70 below edge 71 and adjacent pipe end 36 so as to expose sidewall 49 thereof through the apertures 74. A plug weld 66 is formed to fill flush in each aperture 74 to secure sleeve 70 to pipe 12.

As with the embodiment of FIGS. 2 and 3, aligned bolt holes 65 are provided through the sidewalls 72 and 49 to receive therethrough a number 5 (or better) bolt 50. With reference to FIG. 7, collar 52 to be used with the embodiment of FIGS. 5 and 6 has an inner diameter D8 approximately equal to or slightly larger than the outer diameter D5 of sleeve 70 (and therefore much larger than diameter D2 of pipe 12) so as to removably receive therein sleeve 70 with pipe end 36. As above, bolt holes 67 are provided in collar wall 68 to also receive bolt 50 and secure pipe end 36 to pipe end 40. With sleeve 70 external of pipe 12, there is provided a coaxial pair of pipe sections 36, 70 with a collective wall thickness W3 greater than wall thickness W1. Advantageously, wall thickness W4 of sleeve 70 is approximately equal to wall thickness W1 so as to provide at end 36 a double wall thickness of pipe for joining to pipe 14. The collective wall thickness W3 is believed to provide the ability to withstand the transfer of torque between shafts 12 and 14 at the high levels of torque expected to be encountered while using only one bolt 65 to couple shafts 12 and 14 together, thereby eliminating the need for, and drawbacks associated with use of, multiple bolts to couple the shafts together.

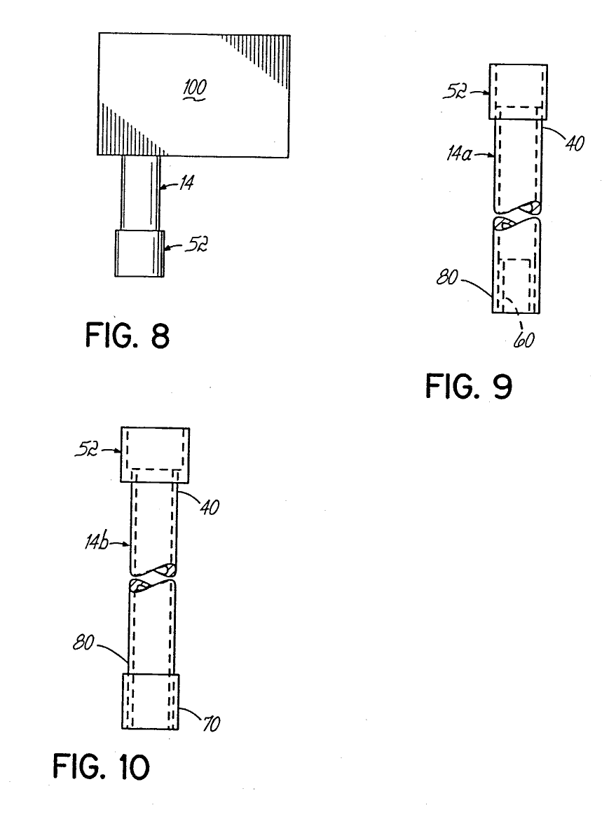

Pipe 14 may be the shaft of a torque motor driver 100 as shown in FIG. 8. End 40 may thus be provided with the appropriately sized collar 52 (as shown in FIG. 8) or sleeve 60, 70 depending upon how end 36 of shaft 12 is configured. When shafts 14 and 12 are bolted together as above-described, activation of driver 100 will impart rotational torque through shaft 14 to shaft 12 to rotate helix blade 20 and, if present, blade(s) 21.

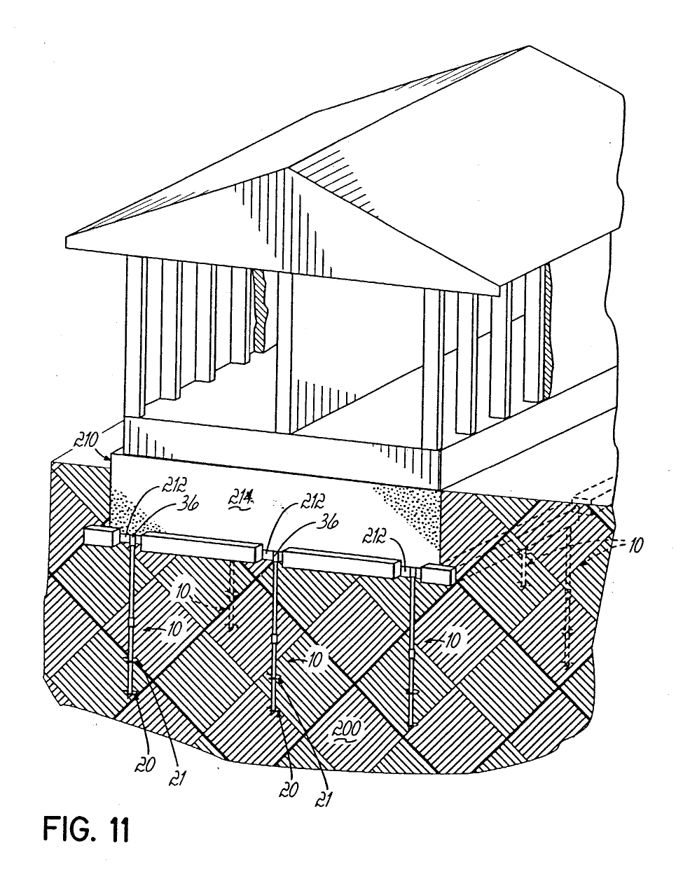

For extension of shaft 12, shaft 14 may be an extension shaft 14a or 14b as shown in FIGS. 9 and 10, respectively. In those embodiments, when a collar 52 is mounted to end 40 of pipe 14a or 14b, the other end 80 of pipe 14a or 14b is provided with either an internal or external sleeve 60 (FIG. 9) or 70 (FIG. 10) as above described for attachment to another shaft in succession. Alternatively, where a collar 52 is on pipe 19, end 40 of pipe 14a or 14b includes the sleeve 60 or 70 and the other end 80 of pipe 14a or 14b may be provided with an appropriately sized collar 52.

In use, and with reference to FIG. 11, a plurality of helix blades 20 (and possibly 21, if present) are to be driven into ground 200 by rotation applied to ends 36 of pipes 12. Advantageously, in each system 10, either shaft 12 or shaft 14 (which in the first instance may be part of driver 100) are provided with the enhanced wall thickness sleeve 60 or 70, and an appropriately sized collar 52, and they are joined together by only one bolt 50 extending through bolt holes 65 and 67. A nut 51 may be used to secure bolt 50 in place. Rotation is imparted to shafts 14 by a plurality of drivers 100 to drive respective blades 20 (and 21) into ground 200 such as adjacent a building structure 210 which is to be supported thereon. If blades 20 are driven far enough into ground 200, then shafts 14 and drivers 100 may be removed and the building placed atop ends 36 for support or piering (such as with brackets 212) as is conventional. Alternatively, one or more shafts 12 with blades 20 may be driven into ground 200 at a steep angle (not shown) to provide a tie-back to a foundational wall 214 of building 210. If blades 20 are to go deeper into the ground than is possible with the length of pipes 12, which may be 5 or 6 feet long, then a plurality of second shafts, such as extension shafts 14a or 14b, which may be 1, 5 or 10 feet in length, for example, are to be connected to respective shafts 12 as above described, each with only one bolt 50. Torque is then applied to the respective ends 80 of shafts 14a or 14b which transmit the torque to shafts 12 to rotate blades 20 further into ground 200 as desired. Further extension shafts 14a or 14b may be applied in succession as will be readily apparent to those skilled in the art. The building 210 may be supported on the extension assembly of shafts 12 and extension shafts 14a or 14b, for example.

Pipes 12, 14, sleeves 60, 70, and collar 52 may be ASTM A-513 1015/1020 @ 70 KSI Ultimate Tensile/Compression steel. Sleeves 60, 70 advantageously have a wall thickness W2, W4 of about ¼ inch, and are advantageously about six inches long. The outer diameter D4 of sleeve 60 is advantageously about 2½ inches. The wall 68 of collar 52 for use with the sleeve 60 embodiment of FIGS. 2 and 3 has a thickness about ¼ inch thick, and has a length of about five inches, and an outer diameter of about 1⅝ inch. Advantageously, collar 52 is slid over shaft end 40 (or 36) to about ⅞ inch from the end and welded full circumference thereto as at 230.

By virtue of the foregoing, there is thus provided an improved helix blade system which may attach with a single bolt, and yet has improved torsional strength.

While the present invention has been illustrated by the description of embodiments thereof and specific examples, and while the embodiments have been described in considerable detail, it is not intended to restrict or in any way limit the scope of the appended claims to such detail. Additional advantages and modifications will readily appear to those skilled in the art. For example, although only one bolt hole set is shown at 16, multiple bolt hole sets may be provided for various purposes, including longitudinal offset of the pipes and/or use of multiple bolts, if desired. Further, while the term collar is used, it will be appreciated that the term is meant to include receiver, socket or other such structure intended to receive therein the coaxial pair of the attachment end and the sleeve of another shaft of the helix blade system. Still further, while cylindrical pipe shafts or sections are shown, it will be appreciated that tubular pipes or other cross-sections may be used, such as square or hexagonal tubes. Moreover, the interior of the pipe may be filled with material such as grout, glue or concrete, as will be readily appreciated by those skilled in the art. The invention in its broader aspects is, therefore, not limited to the specific details, representative apparatus and method, and illustrative examples shown and described. Accordingly, departures may be made from such details without departing from the spirit or scope of the general inventive concept.

Having described the invention, what is claimed is:

1. A helix blade system comprising:
a tubular pipe shaft having an attachment end;
at least one helix blade coupled to the shaft;
a sleeve affixed along the attachment end of the shaft in overlapping relationship therewith; and
means in the sleeve and in the shaft for receiving a bolt whereby when the sleeve and shaft are received in a collar, they may be bolted thereto with a single bolt and withstand applied torque from the collar to cause rotation of said helix blade.

2. The helix blade system of claim 1, the sleeve being interior of the shaft.

3. The helix blade system of claim 1, the sleeve being exterior of the shaft.

4. The helix blade system of claim 1, the sleeve and the shaft being affixed together.

5. The helix blade system of claim 4 further including a plug weld whereby to affix the sleeve to the shaft.

6. The helix blade system of claim 1, the pipe shaft being cylindrical.

7. The helix blade system of claim 6, the sleeve being cylindrical.

8. The helix blade system of claim 1, the sleeve being cylindrical.

9. A first tubular shaft of a helix blade system having an attachment end adapted to be removably received in a collar attached to a second shaft of said helix blade system, the attachment end having a first wall thickness and a sleeve affixed thereto in overlapping relationship, the sleeve having a second wall thickness; and bolt receiving means formed through the wall thicknesses of both the attachment end and the sleeve whereby to be bolted to said collar when the attachment end is received therein so as to couple torque between the shafts and rotate a blade supported on one of said shafts.

10. The first tubular shaft of claim 9, the sleeve being interior of the attachment end.

11. The first tubular shaft of claim 9, the sleeve being exterior of the attachment end.

12. The first tubular shaft of claim 9, the wall thickness of the sleeve and the wall thickness of the attachment end being approximately equal.

13. The first tubular shaft of claim 9, the attachment end being cylindrical.

14. A first tubular shaft of a helix blade system having an attachment end adapted to be removably received in a collar attached to a second shaft of said helix blade system, the attachment end comprising a pair of coaxial pipe sections affixed together to define a collective wall thickness greater than a wall thickness of either pipe section, and bolt receiving means formed through the collective wall thickness of the pair of pipe sections.

15. The first tubular shaft of claim 14, the coaxial pipe sections being cylindrical.

16. An extension shaft for a helix blade system comprising:
a cylindrical pipe having a first end and a second end, the pipe having an inner diameter and an outer diameter defining a first wall thickness;
a cylindrical collar mounted to the first end of the pipe, the collar having an inner diameter;
a cylindrical sleeve mounted in overlapping relationship to the second end of the pipe and having a second wall thickness defined between outer and inner diameters of the sleeve so as to define at the second end of the pipe an overall thickness greater than at least the first wall thickness of the pipe, the inner diameter of the collar corresponding to the outer diameter of one of the sleeve and the second end of the pipe.

17. The extension shaft of claim 16, the sleeve being interior of the pipe second end, the collar inner diameter corresponding to the outer diameter of the pipe.

18. The extension shaft of claim 17, wherein the outer diameter of the sleeve is approximately equal to the inner diameter of the pipe.

19. The extension shaft of claim 16, the sleeve being exterior of the pipe, the collar inner diameter corresponding to the outer diameter of the sleeve.

20. The extension shaft of claim 19 wherein the inner diameter of the sleeve is approximately equal to the outer diameter of the pipe.

21. The extension shaft of claim 16 wherein the wall thickness of the pipe and the wall thickness of the sleeve are approximately equal.

22. A helix blade system comprising in combination:
a first tubular section having a first attachment end and an opposite end and at least one helix blade coupled to the pipe;
a second tubular section have at least a second attachment end; and
a coupler joining the second attachment end of the second tubular section to the first tubular section at the first and second attachment ends, the coupler having (a) a collar attached to one of the first and second attachment ends, and (b) a sleeve affixed in overlapping relationship to the other of the first and second attachment ends and the attachment end and affixed sleeve thereto being received in the collar.

23. The helix blade system of claim 22, the sleeve being internal of the attachment end to which it is affixed.

24. The helix blade system of claim 22, the sleeve being external of the attachment end to which it is affixed.

25. The helix blade system of claim 22, further comprising at least one bolt holding the attachment end and affixed sleeve and the collar together.

26. The helix blade system of claim 25 having only one bolt holding the attachment end and affixed sleeve and the collar together.
